(19) United States
(12) Patent Application Publication
(10) Pub. No.: US 2003/0093294 A1
(43) Pub. Date: May 15, 2003

(54) System providing expanded expert and electronic consultations for clients

(76) Inventor: Philip J. Passantino, Clifton Park, NY (US)

Correspondence Address: MICHAEL P. WILLIAMS, BOND, SCHOENECK & KING, PLLC, ONE LINCOLN CENTER, SYRACUSE, NY, 13202, US

(21) Appl. No.: 10/035,970

(22) Filed: Nov. 9, 2001

(51) Int. Cl. G06F 17/60

(52) U.S. Cl. 705/2

(57) ABSTRACT

A method and system for providing a network of leading experts for use by clients, for example, a payor such as an HMO or an employer, or an engineering firm, and the like, via the Internet. The technique includes recruitment of specialists who are outside of the client's region or who have a valued technical skill, to be a part of a specialty network and for facilitating the obtaining of the appropriate contracts between the specialist and the client. This technique further acts as an intermediary between the client and the client's members/employees who seek referral to a particular specialist of the network, thus allowing a client's members/employees to be quickly and electronically referred to a specialist. This technique is designed to connect any specialist to any client needing special expertise.

### FIELD OF THE INVENTION

The present invention relates to a technique, computer system and method, for providing expanded expert and electronic consultations to clients through a network of specialists researched and accessed over the Internet.

### CROSS REFERENCE

Cross-reference is made to provisional application U.S. Patent Application No. 60/249,812 entitled “Method and System for Providing Expanded Expert and Electronic Consultations for Clients,” filed on Nov. 17, 2000, the entire disclosure of which is hereby incorporated by reference.

### BACKGROUND OF THE INVENTION

Health care is a large and growing market segment, with an estimated 84% of the population's medical costs covered by some form of health insurance. Total U.S. health care expenditures are estimated at $1.2 trillion, which is approximately 14% of the GNP, and private health insurance is $500 billion or 42% of this amount. Over the past two decades, as the cost of this insurance coverage has surpassed the overall rate of inflation, insurers and employers encouraged the growth of “managed care” to help reduce this accelerating pace. While the early savings were easier to achieve, the more recent savings have come in the form of reductions in benefits, services, access and some have suggested quality.

It is estimated there are over 231 million people are covered by health insurance in the U.S. With estimates of more than 80 million enrollees in health maintenance organizations (“HMOs”), another 92 million members in preferred provider organizations (“PPOs”) with approximately half receiving their health insurance through third party administrators (“TPAs”), and approximately 21 million are covered by more traditional indemnity insurance carriers. Clearly, the market for an intermediary to provide services to payors and employers is huge, if the intermediary provides a valuable function.

While HMOs had been experiencing rapid growth over the past decade, this growth has markedly decreased over the past two years. In addition, traditional indemnity payors experienced a decline in both membership and market share as employers sought to control costs with managed care plans. As HMO growth has slowed, the more flexible PPOs, which allow members to visit a much larger network after paying some deductible or co-payment, have been growing more rapidly. The appeal of the Point of Service (“POS”) products are they allow the patient to make an election, at the time of treatment or “point of service,” to remain “in plan” or to go “out of plan,” and incur some combination of higher co-payments and deductibles.

Industry analysts suggest that growing consumer frustration with the inflexibility of managed care plans have contributed significantly to the movement away from these programs. For example, a 1999 survey by the Employee Benefits Research Institute cited that the number one reason members elected to leave managed care plans was their inability to see the physicians of their own choice. This slowing in HMO growth and erosion of both HMO and indemnity market share, compared to the more flexible PPO and POS products, was significant in the time period of 1993 through 1998. Charts show that PPOs have grown by 148%, while POSs have grown by 257% in this time period. Management believes this movement towards the more flexible POS and PPO products is a symptom of a much deeper problem for the HMOs, and illustrates the reluctance of consumers to have financial considerations dominate their medical care decisions. MedViz.com is designed to be a “win-win” for patients, physicians and payors by making world-class specialists and medical advice available to patients covered by small to mid-sized payors.

Recent experience has shown that business-to-consumer (“B2C”) Internet-related companies have experienced mixed results, whether in health care or other service areas. This is due to their reliance on consumer spending habits, retail revenue streams and banner advertisements. On the other hand, most observers see a strong future for business-to-business (“B2B”) service providers with a sound business model and sustainable revenue stream. Further, it has been estimated that the market for health care B2B sites and telemedicine will grow from between 35% to over 100% during the next five years.

There remains a number of problems associated with delivery of health care under the current system. For instance, it is generally thought that members leave HMOs due to their inability to see desired physicians. When confronted with a startling diagnosis, for example, pediatric brain tumor, and the like, people want the best treatment options available. In addition, small to medium-sized payors, 100,000 to 600,000 members, have limited ability to identify, recruit and maintain specialized provider networks. In the past and presently, HMO's use their physicians who typically are not the best in their field. What is lacking is a way to get the most qualified diagnosis to the patient, for a low cost providing excellent value to the patient.

What is needed is a system for providing expert and electronic consultations for clients through a network of specialist researched and accessed over the Internet that allows clients the freedom to choose their health-care provider or obtain consultations at a reasonable cost.

### SUMMARY OF THE INVENTION

It is an aspect of the invention to provide easy access to specialized medical consultation and care.

It is another aspect of the invention to improve efficiency in the delivery of health care and the efficiency of medical insurance providers.

These and other aspects are attained by a computerized method of recruiting and credentialing a network of specialized experts, and storing this information for electronic consultations to clients on a centralized data storage medium. This includes providing a secure and limited access to a client by a networked computer system, displaying selected information to the client, providing means to select a specialized expert in response to an inquiry, search or other request being made by the client, and receiving and processing a request from a client and displaying said information about the selected expert to the client. The method further includes accessing the profile of the selected expert, providing specific inquiries to the client, wherein the specific inquiries are generated by the selected expert, assisting the client in automatically capturing and uploading information in a format that will allow the server to encrypt and secure the information for transmission to the designated expert, and interfacing with the clients own systems to extract any available background or demographic information. This is to most efficiently capture previously-stored information to minimize re-entering the information or creating data entry or transcription errors. Finally, the method includes retrieving any additional information previously stored for the client to appropriately confirm the identity of the client to the server and insure the security and integrity of the information to be transmitted, generating a request to the designated expert to obtain the specialized expertise required for the clients specific needs, and tracking and fulfilling the generated request to complete the desired referral, whereby the referral is obtained from a leading expert. This is accomplished without the person needing to physically travel to a distant location or maintain an expensive, rare, with limited access or availability or otherwise infrequently used expertise within their local area.

These and other aspects of this invention will become apparent from the following description, the description being used to illustrate a preferred embodiment of the invention when read in conjunction with the accompanying drawings.

### BRIEF DESCRIPTION OF THE DRAWINGS

FIG. 1 is a flow chart diagram depicting the application architecture.

FIG. 2 is a flow chart diagram depicting the preferred embodiment of the present inventive method for a network access request.

FIG. 3 is a flow chart diagram depicting the preferred embodiment of the present inventive method for medical efficacy review.

FIG. 4A is a flow chart diagram depicting the preferred embodiment of the present inventive method for client referral request process.

FIG. 4B is a flow chart diagram depicting the preferred embodiment of the present inventive method. for client referral request process.

FIG. 4C is a flow chart diagram depicting the preferred embodiment of the present inventive method for client referral request process.

FIG. 5 is an overview of the flow chart diagram of the preferred embodiment of the present inventive method for the central telemedicine database management system.

### DETAILED DESCRIPTION OF THE INVENTION

While the present invention is described below with reference to healthcare, a practitioner in the art will recognize the principles of the present invention are applicable in other applications.

The Internet is comprised of a large number of computers and computer networks that are interconnected through communication links. These computers exchange information using various services, such as electronic mail, Gopher, and the World Wide Web (“WWW”). The World Wide Web allows a computer system, for example, a Web server or Web site, to send graphical Web pages of information to remote client computer systems. The remote client computer system can access these Web pages through each page's unique Uniform Resource Locator (“URL”). To view a specific Web page, a client computer system specifies the URL for that Web page in a request using the Hyper Text Transfer Protocol (“HTTP”) language. When the client computer system receives that Web page, it typically displays the Web page using a browser. A browser is a special-purpose application program, for example Internet Explorer, Netscape, and the like, that then displays the requested Web page(s).

The inventive process herein described, sometimes referred to hereinafter as Medviz.com, provides medical reference services to payors such as health maintenance organizations (“HMOs”), Point of Service (“POS”) plans, preferred provider organizations (“PPOs”), third-party administrators (“TPAs”), large, self-insured employers and traditional indemnity insurance carriers (“indemnity”). These payors and employers, hereinafter, will collectively be referred to as “clients.” By connecting these clients with a nationally-recognized panel of distinguished and “thought-leader” physicians, who have specialized expertise in treating difficult medical conditions and “startling diagnoses”, the process helps these clients reduce their health care costs while improving the overall quality of patient health care.

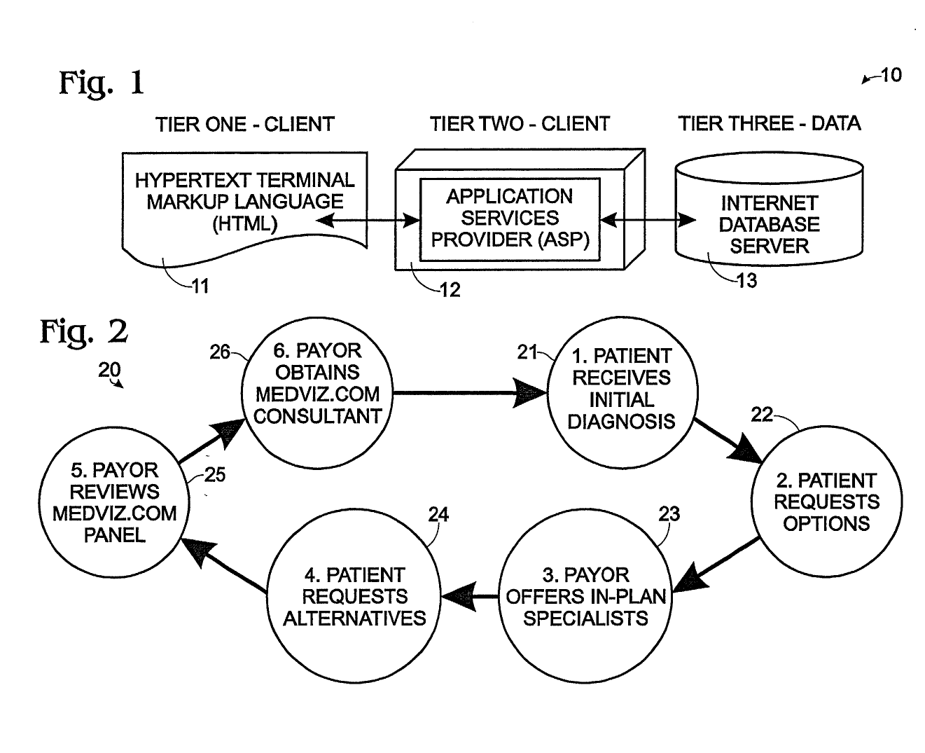

The computerized method process architecture 10 is based on a three-tier model, as shown in FIG. 1. The Tier One 11 provides the graphical user interface (“GUI”) with personalization ability specific to such items as user data requests, displaying selected information for clients, forms for data entry, local validation of data, for example, provider, patient, participant, and the like. The Tier Two 12 consists of an application server to handle such items as connections from the client tier, performing much of the business logic, interfaces to the database, and the like. Finally, Tier Three 13 consists of the Internet database server and physical database stores.

As the need arises for its payor clients, MedViz.com will provide the means to select a specialized expert in response to an inquiry, search or other request being made by the client. This includes profiles of one or more consultant physicians, for example, a neurologist or brain surgeon skilled to meet the specific needs of the patient or facilitate the transfer of patient information to the leading physician. Other profiles cover the costs of the initial electronic or face-to-face consultation, and negotiate discounted rates at the physician's associated hospital. MedViz.com will be responsible for the development and costs of the consultant network recruitment and servicing, technology infrastructure, the cost of the initial electronic face-to-face medical consultations and the independent medical efficacy reviews. The payor will cover these costs through the per member per month pre-payment rate paid to MedViz.com, and will be responsible for the costs of all significant procedures and inpatient hospitalizations paid to those organizations that generally include the cost of any follow-up consultations.

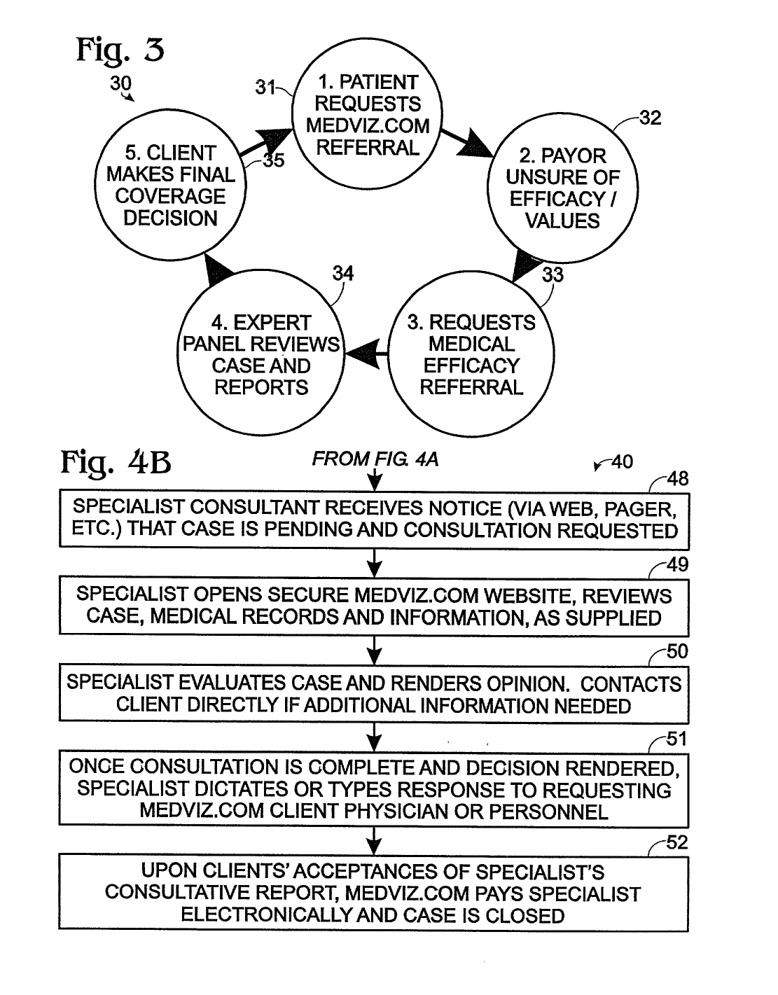

FIG. 2 shows flow chart 20 a six step process wherein a patient initiates a MedViz.com network access request. The first step 21 is having a patient or client receive an initial diagnosis. For example, a “startling diagnosis” includes medical situations involving life threatening or significant health concerns. In these situations, patients naturally desire the best care available, regardless of source, cost or location. Proceeding to the second step 22 the patient or client request their options. MedViz.com receives and processes the request from the client and will display the information about a selected expert to the client as this process proceeds. Historically, a conflict arises because payors have favored the “in-plan” referral to a physician or provider who has a contractual relationship with the payor, due to concerns about cost and loss of control.

In step three 23, the payor offers in-plan specialist. As a facilitator in this environment MedViz.com, identifies and recruits the specialist physician panel with corresponding hospitals, develops and maintains the information technology and telemedicine backbone with the associated database, accesses the profile of the selected expert, and oversees the availability of a sufficiently robust health delivery network to insure its clients have access to the breadth and scope of the most current services required by these patients. The fourth step 24 is where the patient requests alternatives. MedViz.com provides specific inquiries to the patent or client whereby the specific inquiries are generated by the selected expert. Furthermore, if a client is concerned about the appropriateness, for example, efficacy or effectiveness of a proposed treatment plan, MedViz.com will arrange for the proposed treatment plan to be reviewed by an independent physician panel on a timely basis, wherein step five 25 the payor then reviews MedViz.com proposal(s). Finally, in step six 26 the payor obtains the MedViz.com consultation.

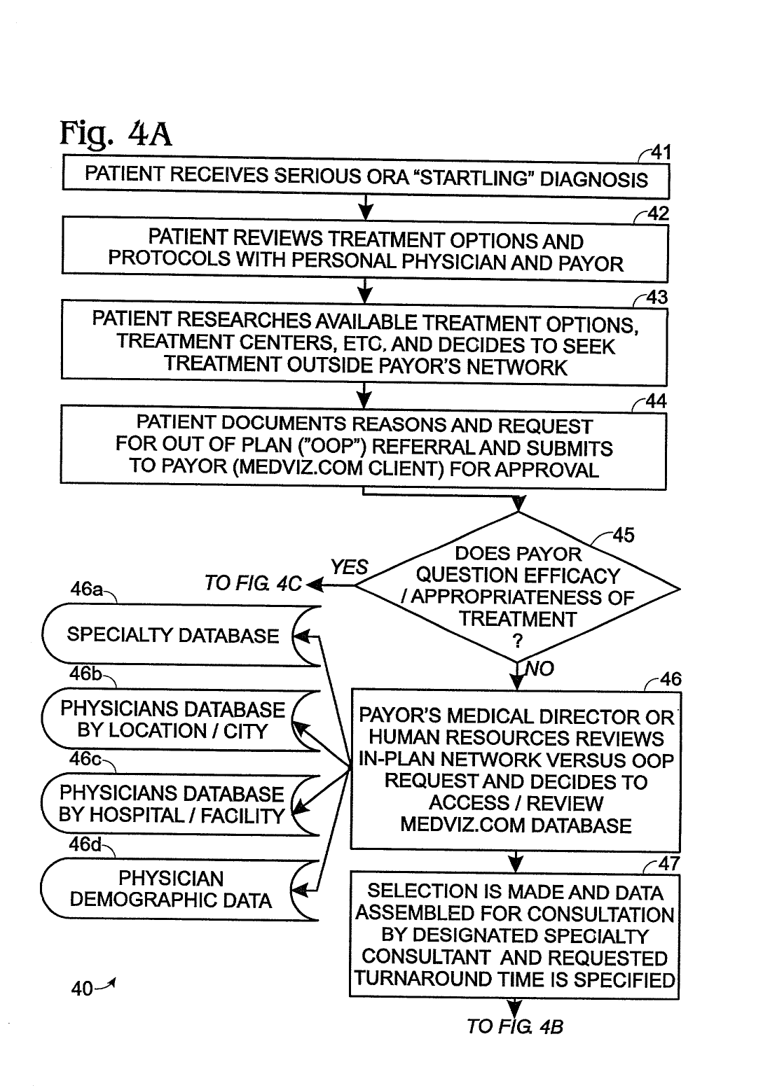

In addition, the system provides a review of the medical efficacy (appropriateness), as shown in FIG. 3, of the record to ensure that the proposed diagnostic or treatment protocols are appropriate for the client's member/employee. As a further extension the invention provides access to a telemedicine-based medical record database management system, accessible through a secure and limited-access Internet connection, by the use of a networked computer system, to confidentially collect and transmit client's member/employee medical information for the specialists. MedViz.com assists the client in automatically capturing and uploading information that will allow a server to encrypt and secure the information for transmission to the designated expert. Additionally, the invention provides access to a central system which facilitates secure access to the network of specialists, on-line referral requests and specialist responses, clients' member/employee medical records and related medical information.

The medical efficacy review flow chart 30 is a 5-step process. The first step 31 is for the patient to request a MedViz.com referral. If the payor is unsure of the efficacy/value in step two 32, then at step three 33 the payor requests a medical efficacy review. Next during step four 34 a panel of experts will review the case and report back, wherein step five 35 allows the client to make a final coverage decision.

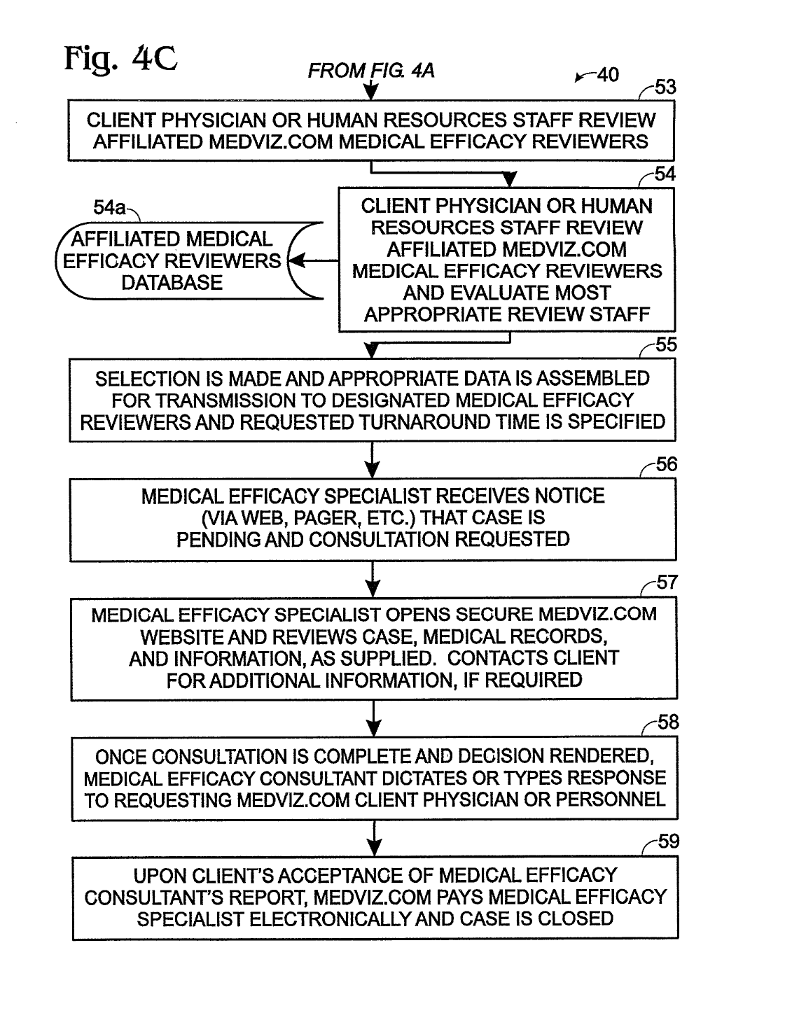

In FIGS. 4A, 4B and 4C, flow chart 40 shows the process and system of the MedViz.com client referral request procedure. The process starts with the first step 41 where a patient receives a serious or startling diagnosis for an illness. MedViz.com retrieves any additional information previously stored for the client to appropriately confirm the identity of the client to the server and insure the security and integrity of the information to be transmitted. In the second step 42, the patient reviews treatment options and protocols with a personal physician and the payor. At the next step three 43 the patient researches available treatment options, treatment centers, and the like, and then decides to seek treatment outside of the payor's network. For payors, the key client representative(s) who interface directly with MedViz.com would be the medical director or the human resources staff. It should be noted that as a business-to-business supplier, MedViz.com does not seek to have a direct patient contact role. While MedViz.com staff will be available to assist its clients as requested the clients do not need nor desire an additional communications channel, with the patient or employee, as the direct communication between them works best. In its facilitator role, this simplifies many operational requirements for MedViz.com. Furthermore, MedViz.com interfaces with the clients own systems to extract any available background or demographic information, to most efficiently capture previously-stored information that minimizes re-entering the information or creating data entry or transcription errors.

The fourth step 44 the patient documents reasons and request for Out of Plan (“OOP”) referral and submits to payor a MedViz.com client for their approval. At this fifth step 45 the payor will either agree or disagree with the efficacy/appropriateness of the treatment. In those cases where a MedViz.com client is unsure whether the requested referral is appropriate for the patient, they will access one of the affiliated MedViz.com medical efficacy experts through the MedViz.com site. MedViz.com generates a request to the designated expert to obtain the specialized expertise required for the clients specific needs. These established experts, whose fees will be included in the MedViz.com monthly service fee, will fulfill their role of arranging for an independent medical panel to review the case. This review will evaluate matters such as is this a proven or experimental treatment protocol, is there published research and support in the medical literature for this proposed treatment on similar patients with similar medical histories and diagnoses, and the like, and the likelihood of success with the proposed treatment protocol for this patient. It should be noted that the medical efficacy review is simply an objective, independent review. The final decision to approve or deny the treatment or coverage resides with the client's authorized representatives.

If the decision in step five 45 is no, that is, the treatment is not appropriate, then in step six 46, the payor's medical director or human resources will review the in-plan network versus the OOP request and decide to access review the MedViz.com database. These data bases include, but are not limited to, a medical specialty database 46a, a physicians by location database 46b, a physicians by facility database 46c, and a physician demographic data base 46d. The client reviews the available network of specialists for appropriate expertise and assembles the data specified by the specialist consultant. The request for the consultation is placed by the client on the client's system and is received by the server system. The server system receives the request for the consultation together with the types of information specified by the specialist on his or her profile as necessary to render an opinion. In the case of the medical consultation, the server would receive patient demographic information, for example, name, age, and the like, together with medical records and related data including, but not limited to, patient's chart, radiographic exams, digital images, and the like, to render a diagnosis or recommend a treatment plan. Furthermore, MedViz.com tracks and fulfills a generated request to complete the desired referral, whereby the referral is obtained from a leading expert without the person needing to physically travel to a distant location or maintain an expensive, rare with limited access or availability, or otherwise infrequently used expertise within their local area.

At step seven 47 a selection is made and data assembled for consultation by the designated specialty consultant. At the seventh step 47, a requested turnaround time is specified. The eighth step 48 is where the specialist consultant receives notice the case is pending and consultation is requested. Now, at the ninth step 49 the specialists opens the secure MedViz.com website and reviews the case with the supplied medical records and information.

The server notifies the designated specialist, via E-mail, pager, fax, wireless Internet palm pilot, and the like, that a consultation is pending and tracks turnaround time until the case is closed or initiates an escalating alert system to insure timely action is taken. The server is highly secure and verifies the identity of the specialty consultant prior to allowing access. At the tenth step 50, and eleventh step 51, the specialist consultant evaluates the case by reviewing the information received, renders a decision and uses the system or the telephone to dictate or type a final report. Upon acceptance of the report by the client, at the twelfth step 52, the specialist receives an electronic remittance.

If the decision at step five 45 is yes, that is, the payor does question the appropriateness of the treatment then the payor goes on to step thirteen 53. At this step the client physician or human resources staff reviews the affiliated MedViz.com medical efficacy reviewers, and move on to the fourteenth step 54 where they evaluate the most appropriate efficacy reviewers. The staff has available the affiliated medical efficacy reviewers database 54a to evaluate the most appropriate efficacy reviewers. A selection is made at the fifteenth step 55, and appropriate data is assembled for transmission to the designated medical efficacy reviewers with requested turn around time specified. Once the MedViz.com client has approved the referral, the appropriate medical records components are collected, for example, history and physical, lab results, EKG, and the like, and depending upon the arrangement with each consultant, these are express mailed or faxed to the physician for his (or her) review and diagnosis.

At the sixteenth step 56 the medical efficacy specialist receives notice, for example, through the Web or a pager, that a case is pending and consultation is requested. The medical efficacy specialist proceeds to the seventeenth step 57 where the specialist opens the secure MedViz.com website and reviews the case that includes, but not limited to, medical records, personal information, and the like. The specialist may contact the client, at this point, if additional information is needed to evaluate the case. Once the consultation is complete at the eighteenth step 58, a decision is rendered and the consultant responds to the requesting MedViz.com client, physician or personnel. Finally, at the last step 59, upon client's acceptance of the medical efficacy consultant's report, MedViz.com pays the medical efficacy specialist electronically and the case is closed.

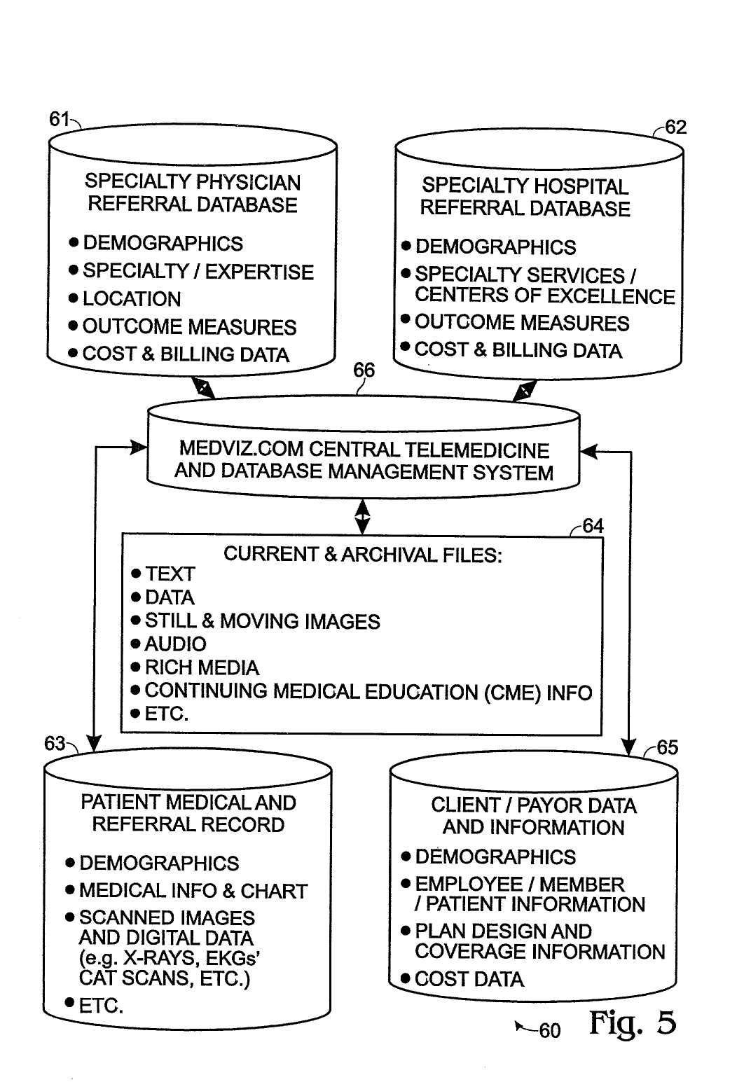

In FIG. 5, flow chart 60 shows an overview of MedViz.com central telemedicine database management system. This system includes a specialty physician referral database 61, a specialty hospital referral database 62, a patient medical and referral record database 63, current and archival files database 64, and a client/payor information database 65. For example, the client/payor data base 65 will include the clients of MedViz.com that shall further comprise payors including, but not limited to, HMOs, PPOs, TPAs, indemnity insurers, and the like, and employer groups including, but not limited to, self-insured employer groups, and the like. These clients will contact with MedViz.com to obtain access to its network of top specialists at leading academic medical centers and other locations across the country including internationally.

Prior to accessing the telemedicine and data base management system 66 an Application is required. The primary purpose of the MedViz.com Application is to provide a limited-access, business-to-business (“B2B”), Internet-based browser application, for the distribution and sharing of patient-specific medical records, provider profiles and participating physician profiles in order to communicate professional medical services over the Internet.

The specialty physician referral database 61 includes, but is not limited to information regarding demographics, specialty and expertise of the doctor, location, outcome measures, and cost and billing information. Along with this database 61 the client can pull information from the specialty hospital referral database 62 that includes, but is not limited to, demographics, special services rendered, hospital centers of excellence, outcome measures, and cost and billing data. Furthermore, the patient medical and referral records database 63 is available to provide information on demographics, medical and chart information, scanned images and digital data, for example, X-rays, EKGs, CAT Scans, and the like. When a user needs client information, for example, demographics, employee/member/patient information, plan design, coverage information, and cost data, they would access the client/payor database 65. Finally, the current and archival database 64 includes, but is not limited to, text, data, still images, moving images, audio, rich media, continuing medical education information, and the like.

While there has been illustrated and described what is at present considered to be the preferred embodiment of the invention, it will be appreciated that numerous changes and modifications are likely to occur to those skilled in the art. It is intended in the appended claims to cover all those changes and modifications that fall within the spirit and scope of the present invention.

What is claimed is:

1. A computerized method of recruiting and credentialing a network of specialized experts and storing this information for electronic consultations to be used by clients comprising:
a) providing a secure and limited access to a client by the use of a networked computer system;
b) displaying selected information to the client;
c) providing means to select a specialized expert in response to an inquiry, search or other request being made by the client;
d) receiving and processing a request from a client and displaying said information about a selected expert to the client;
e) accessing the profile of the selected expert;
f) providing specific inquiries to the client, said specific inquiries generated by the selected expert;
g) assisting the client in automatically capturing and uploading information, from a data base, in a format that will allow the server to encrypt and secure the information for transmission to the designated expert;
h) interfacing with the clients own systems to extract any available background or demographic information to most efficiently capture previously-stored information to minimize re-entering the information or creating data entry or transcription errors;
i) retrieving any additional information previously stored for the client to appropriately confirm the identity of the client to the server and insure the security and integrity of the information to be transmitted;
j) generating a request to the designated expert to obtain the specialized expertise required for the clients specific needs; and
k) tracking and fulfilling the generated request to complete the desired referral, said referral is obtained from a leading expert without the person needing to physically travel to a distant location or maintain an expensive, rare, with limited access or availability or otherwise infrequently used expertise within their local area.

2. The computerized method as claimed in claim 1, wherein said networked computer system is connected to a central telemedicine data base.

3. The computerized method as claimed in claim 2, wherein said data base is selected from the group consisting of the world wide web, email, gopher, specialty physician referral, specialty hospital referral, patient medical record referral, current file, archival file, and client/payor.

4. The computerized method as claimed in claim 3, wherein said server accesses said data bases.

5. The computerized method as claimed in claim 1, wherein said clients are selected from the group consisting of HMOs, PPOs, POS plans, TPAs, self-insured employers, patients, physicians, indemnity insurance carriers, and payors.

6. The computerized method as claimed in claim 1, wherein said format further includes a graphical user interface.

7. The computerized method as claimed in claim 6, wherein said graphical user interface provides items selected from the group consisting of user data requests, displaying client information, data entry forms, local validation of data, user information, demographics, scanned images, digital data, chart information, cost data, outcome measures, billing data, specialty/expertise data, location data, current data, special services data, and archival data.

8. The computerized method as claimed in claim 1, wherein said server notifies the designated specialist by means selected from the group consisting of e-mail, pager, fax, and palm pilot.
